(19) United States
(12) Patent Application Publication
(10) Pub. No.: US 2020/0037802 A1
(43) Pub. Date: Feb. 6, 2020

(54) CHRISTMAS TREE

(71) Applicant: QIUHUA ZHOU, DONGGUAN (CN)

(72) Inventor: Zhibin Zhou, Dongguan (CN)

(73) Assignee: QIUHUA ZHOU

(21) Appl. No.: 16/595,485

(22) Filed: Oct. 8, 2019

Related U.S. Application Data
(63) Continuation-in-part of application No. 15/216,665, filed on Jul. 21, 2016.

(30) Foreign Application Priority Data
Dec. 25, 2015 (CN) 201521093345.2

(51) Int. Cl. A47G 33/06; F21S 4/10

(52) U.S. Cl. CPC A47G 33/06; F21W 2121/04; F21S 4/10

(57) ABSTRACT

The present invention disclose a Christmas tree, comprising a plurality of trunk units capable of being assembled, wherein the trunk unit is a hollow tubular body; when any two trunk units are connected, the lower end of the tubular body located above is sleeved into the upper end of the tubular body located below; the trunk unit comprises a power connector comprising an upper end connecting portion and a lower end connecting portion, the upper end connecting portion and the lower end connecting portion are respectively arranged at both ends of the tubular body. The present invention can avoid the adverse effects caused by the reverse connection of the positive and negative electrodes, and improve the convenience and safety of the assembly and use of the Christmas tree.

### TECHNICAL FIELD

The embodiments of the present invention relate to the field of Christmas trees, and more particularly to an electrical connection tree pope of a Christmas tree.

### BACKGROUND

In Europe and the United States, Christmas trees are widely used as a decoration for Christmas. The Christmas tree is the most commonly used artificial tree-like ornament for Christmas celebrations. It is mainly composed of a base, a trunk, branches and colored lights. In order to facilitate storage and transportation, the trunk is generally constructed by connecting two or more hollow tubes, each of which is provided with branches decorated with colored lights. In order to supply power for the colored lights on the upper branches, the traditional Christmas trees are provided with a plug and a socket for mating between the upper and lower branches. After the tubes of the trunk are connected with each other, the plugs are manually plugged into and the sockets, which is inconvenient to operate, especially for a large Christmas tree. Because of the shelter of the branches, it is not easy to find and plug the plug to the right socket. In general, DC colored lights is provided with positive and negative electrodes. If the light string is connected reversely, the light bulb will not be light or burn, out, and even a short circuit or fire will occur. However, the assembly of the conventional plug and socket is easy to cause the light string to be reversed.

### SUMMARY

The object of embodiments of the present invention is to provide a Christmas tree. When any two trunk unit are connected, the positive and negative electrodes of the power source can be accurately connected, which can avoid the light bulbs from being not bright or burned due to the reverse connection of the positive and negative electrodes.

The embodiment of the present invention provides a Christmas tree, comprising a plurality of trunk units that can be connected with each other, wherein the trunk unit comprises: a hollow tubular body comprising an upper tubular body and a lower tubular body, wherein the inner diameter of the upper tubular body is slightly larger than the outer diameter of the lower tubular body; and a power connector comprising an upper end connecting portion arranged in the upper tubular body and a lower end connecting portion arranged at the orifice of the lower tubular body; wherein the upper end connecting portion comprises a first bevel with a positive electrode metal piece and a negative electrode metal piece arranged on the slope of the first bevel, the lower end connecting portion comprises a second bevel with a positive electrode metal piece and a negative electrode metal piece on the slope of the second bevel, and the upper end connecting portion is electrically connected to the lower end connecting portion; when any two trunk units are connected, the lower tubular body of one of the two trunk units is sleeved into the upper tubular body of the other trunk unit from the orifice of the upper tubular body of the other trunk unit, so that the slope of the second bevel of the lower tubular body of the one of the two trunk units abuts against the slope of the first bevel of the upper tubular body of the other trunk unit, the positive electrode metal piece on the second bevel of the one of the two trunk units abuts against the negative electrode metal piece on the first bevel of the other trunk unit, and the negative electrode metal piece on the second bevel of the one of the two trunk units abuts against the positive electrode metal piece on the first bevel of the other trunk unit.

In some embodiments, the trunk unit further comprises a power interface embedded in a mounting hole arranged on the surface of the tubular body of the trunk unit, and the power interface is electrically connected to the power connector in the tubular body.

In some embodiments, the upper end connecting portion further comprises a first supporting base and a first fixing assembly, the first bevel is on the top of the first supporting base, and the first supporting base is fixed in the upper tubular body by the first fixing assembly, configured to support the upper end connecting portion and to make the first bevel towards the orifice of the upper tubular body; the lower end connecting portion further comprises a second supporting base and a second fixing assembly, the second bevel is on the top of the second supporting table, and the second supporting base is fixed in the lower tubular body by the second fixing assembly, configured to support the lower end connecting portion and to make the second bevel towards the orifice of the lower tubular body.

In some embodiments, the fixing assembly comprises a lock snap assembly and/or a threaded assembly.

In some embodiments, a buffer fixing ring is provided in the tube between the orifice of the upper tubular body and the upper end connecting portion.

In some embodiments, the surface of the upper tubular body and the lower tubular body of the trunk unit are respectively provided with a socket mark; when any two trunk units are connected, the socket mark of the lower tubular body of one of the two trunk units is aligned with the socket mark of the upper tubular body of the other trunk unit.

In some embodiments, a guide block is arranged on the outer surface of the lower tubular body, and a guide groove is arranged on the inner surface of the upper tubular body; when any two trunk units are connected, the guide block of the lower tubular body of one of the two trunk units slides along the guide groove in the upper tubular body of the other trunk unit, to make the slope of the second bevel of the lower tubular body of the one of the two trunk units abutted against the slope of the first bevel of the upper tubular body of the other trunk unit.

In some embodiments, the socket mark is colored.

Embodiments of the present invention provide a Christmas tree, wherein an upper end connecting portion, comprising a first bevel provided with positive and negative electrode metal pieces, is arranged on an upper tubular body of the trunk unit, a lower end connecting portion, comprising a second bevel provided with the positive and negative electrode metal pieces, is arranged on the lower tubular body, and the inner diameter of the upper tubular body is equal to or slightly larger than the outer diameter of the lower tubular body. Thus, when any two trunk units are connected, the lower tubular body of one of the two trunk units can be directly sleeved into the upper tubular body of the other trunk unit, and the slopes of the two tubular bodies abuts against each other. The positive electrode metal piece and the negative electrode metal piece on the two slopes can be connected to each other quickly and accurately, which avoids the light bulbs from being not bright or burned due to the reverse connection of the positive and negative electrodes, and improves the convenience and safety of the Christmas tree assembly.

### BRIEF DESCRIPTION OF THE DRAWINGS

In the drawings, the same reference numbers in multiple drawings refer to the same or similar parts or elements, unless otherwise specified. These drawings are not necessarily drawn at scale. It should be understood that these drawings describe only some embodiments under this disclosure and should not be considered as a limitation on the scope of the invention.

FIG. 1 is a schematic view showing the structure of a trunk unit according to an embodiment of the present application,

FIG. 2 is a schematic view showing the structure of the connection of any two trunk units according to an embodiment of the present application;

FIG. 3 is a schematic view showing the structure of an upper end connecting portion of a power connector according to an embodiment of the present application.

FIG. 4 is a schematic view showing the structure of a lower end connecting portion of the power connector of the embodiment of the present application.

### DESCRIPTION OF THE REFERENCE NUMBERS

100—trunk unit; 101—first trunk unit; 102—second trunk unit;

1—tubular body; 11—upper tubular body; 12—lower tubular body; 13—mounting hole;

2—power connector;

21—upper end connecting portion; 211—first bevel; 212—first supporting base; 213—first lock snap assembly; 214—positive electrode metal piece; 215—negative electrode metal piece;

22—lower end connecting portion; 221—second bevel; 222—second supporting base; 223—second lock snap assembly; 224—positive electrode metal piece; 225—negative electrode metal piece;

3—power interface.

### DETAILED DESCRIPTION OF EMBODIMENTS

The embodiments of the present application are described in detail below.

In the embodiments of the present application, the Christmas tree may be composed of a plurality of trunk units 100 that can be connected with each other. The trunk unit 100 is a hollow tubular body.

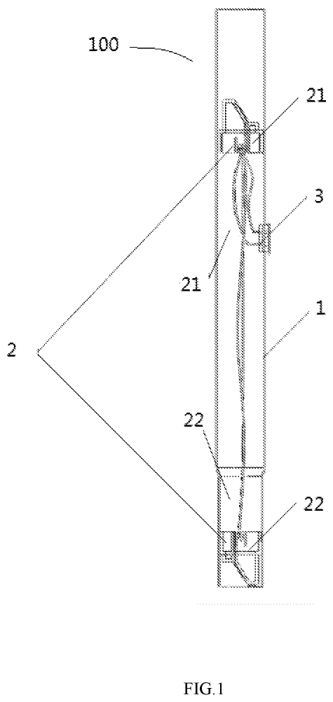

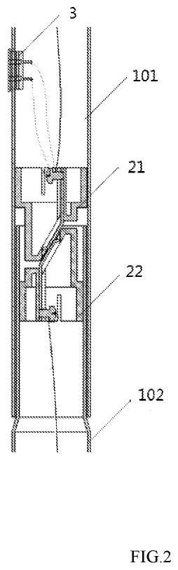

As shown in FIGS. 1 and 2, when any two trunk units 100 are connected, the lower end of the tubular body 1 of the trunk unit 100 located above is sleeved with the upper end of the tubular body 1 of the trunk unit 100 located below. The trunk unit 100 may comprise a tubular body 1, a power connector 2, and a power interface 3. The tubular body 1 may comprise an upper tubular body 11, a lower tubular body 12, and a mounting hole 13 (not shown) The inner diameter of the orifice of the upper tubular body 11 is slightly larger than the outer diameter of the orifice of the lower tubular body 12, so that the upper tubular body 11 of the trunk unit 100 located above is sleeved with the lower tubular body 12 of the trunk unit 100 located below. The mounting hole 13 can be used to embed the power interface 3 therein. The power connector 2 comprises an upper end connecting portion 11 and a lower end connecting portion 12 having the same outer shape and structure, and the upper end connecting portion 11 and the lower end connecting portion 12 are respectively arranged at both ends of the tubular body 1. For example, the upper end connecting portion 11 is provided in the upper tubular body 11, the lower end connecting portion 12 is provided in the lower tubular body 12. The upper end connecting portion 11 in the tubular body 1 is electrically connected to the lower end connecting portion 12. As shown in FIG. 1, it can be connected by wires. When any two trunk units 100 are connected, the upper end connecting portion 11 of the power connector 1 of one of the trunk units is electrically connected to the lower end connecting portion 12 of the power connector 1 of the other trunk unit.

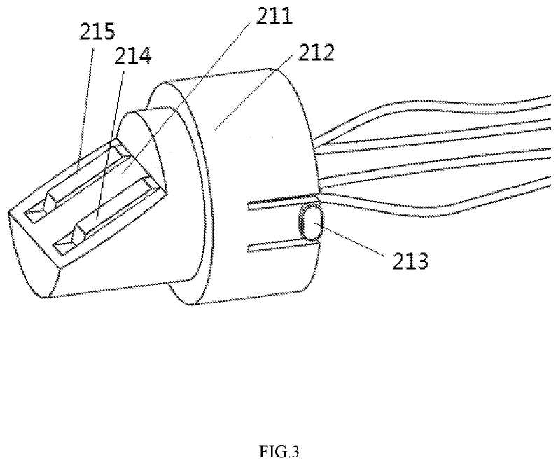

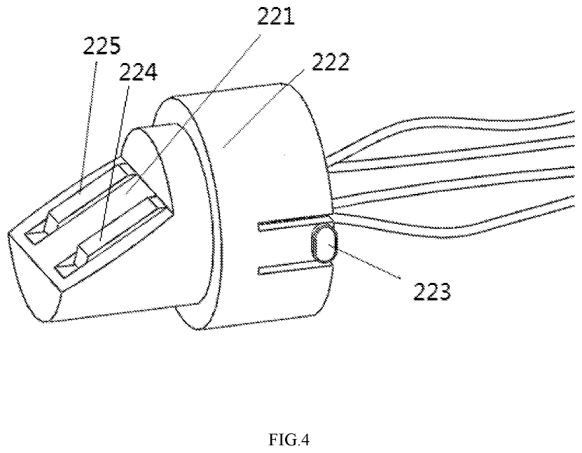

As shown in FIG. 3, the upper end connecting portion 21 may comprise a first bevel 211, a first support base 212, and a first lock snap assembly 213. A positive electrode metal piece 214 and a negative electrode metal piece 215 are respectively arranged on the slope of the first bevel 211. The first bevel 211 is on the top of the first supporting base 212, and the first support base 212 is fixed in the upper tubular body 11 by the first lock snap assembly 213 for supporting the first bevel 211 to make the first bevel 211 faces the orifice of the upper tubular body 11. In some embodiments, the lower end connecting portion 22 has the same structure as the upper end connecting portion 21, except that the respective components are different from the reference numbers, and specifically, the lower end connecting portions in FIG. 4 can be compared with FIG. 3. The lower end connecting portion 22 comprises a second bevel 221, a second supporting base 222, and a second lock snap assembly 223. A positive electrode metal piece 224 and a negative electrode metal piece 225 are respectively arranged on the slopes of the second bevel 221. The second bevel 221 is on the top of the second supporting base 222, and the second supporting base 222 is fastened and fixed in the lower tubular body 12 by the second lock snap assembly 223.

As shown in FIG. 1, the upper end connecting portion 21 is located in the upper tubular body 11 and has a certain distance from the orifice. The lower end connecting portion 22 is located near the orifice of the lower tubular body 12. The distance between the lower tubular body 12 at the boundary where the diameter starts to increase and the orifice of the lower tubular body 12 is L1. The top of the slope of the second bevel 221 of the lower end connecting portion 22 is flush with the orifice of the lower tubular body 12. The distance between the bottom of the slope of the first bevel 211 of the upper end connecting portion 21 and the orifice of the upper tubular body 11 is L2, and L2 is equal to L1 Based on the fact that L1 and L2 are equal, the upper tubular body 11 and the lower tubular body 12 of the tubular body 1 are respectively provided with snap-on holes (not shown) at corresponding positions. When the upper end connecting portion 21 is fixed to the upper tubular body 11, the first lock snap assembly 213 can be caught in the snap-on hole of the upper tubular body 11, and the distance between the upper end connecting portion 21 and the orifice of the upper tubular body 11 satisfies the requirement of L2. When the lower end connecting portion 22 is fixed to the lower tubular body 12, the second lock snap assembly 223 can be caught in the snap-on hole of the lower tubular body 12, and the top of the slope of the second bevel 221 of the lower end connecting portion 22 is flush with the orifice of the lower tubular body 12.

In the embodiments of the present invention, since the structures of the upper end connecting portion 21 and the lower end connecting portion 22 are the same, the upper end connecting portion 21 and the lower end connecting portion 22 can be randomly mounted on the both ends of the trunk unit during the assembly of each trunk to avoid assembly errors.

In some embodiments, the first lock snap assembly 213 and the second lock snap assembly 223 may be replaced with a threaded assembly. The threaded assembly may be provided with a threaded hole on the side of the bevel or the supporting base, and a hole aligned with the threaded hole is provided on the trunk unit 100. Screw the screw from this hole outside the trunk unit 100 into the threaded hole to secure the connection of the power connector. In some embodiments, the power connector is better secured with the lock snap assembly and the threaded assembly at the same time. The lock snap assembly and the threaded assembly are components that can be used for fixing.

For any connected two trunk units 100, it is possible to assume that one of the trunk units is the first trunk unit 101 and the other trunk unit is the second trunk unit 102. As shown in FIG. 2, the lower tubular body of the second trunk unit 102 is sleeved and rotated into the upper tubular body of the first trunk unit 101 from the orifice of the upper tubular body of the first trunk unit 101, to make the slope of the second bevel 221 of the second trunk unit 102 abutted against the slope of the first bevel 211 of the first trunk unit 101, the positive electrode metal piece 214 of the first trunk unit 101 abutted against the negative electrode metal piece 225 of the second trunk unit 102, and the negative electrode metal piece 215 of the first trunk unit 101 abutted against the positive electrode metal piece 224 of the second trunk unit 102. The metal piece may be an elastic piece of metal, such as a spring or shrapnel. The positive and negative electrode metal pieces may be respectively arranged on the left and right sides of the vertical direction of the slope of the bevel, or may be arranged on the upper and lower sides of the vertical direction of the slope, and the other symmetric arrangement of the other positive and negative electrode metal pieces is also possible. The positions of the positive and negative electrode metal pieces on the slopes of the upper end connecting portion 21 and the lower end connecting portion 22 are the same, except that the bevel of the upper end connecting portion 21 faces the orifice of the upper tubular body 11, and the bevel of the lower end connecting portion 22 faces the orifice of the lower tubular body 12.

In some embodiments, at least one trunk unit 100 of the Christmas tree further comprises a power interface 3 embedded in a mounting hole arranged on corresponding the surface of the trunk unit 100, and the power interface 3 is electrically connected to the corresponding power connector 1. Since each of the power connector 1 is connected in series after the connection of all the trunk units 100 is completed, the power connector 3 can be arranged in the trunk unit 100 at the lowermost end of the Christmas tree for access to power. In this way, it is not necessary to provide a power interface for each trunk unit.

In some embodiments, when any two trunk units 100 are connected, the lower tubular body 12 of the second trunk unit 102 collides with the upper tubular body 11 of the first trunk unit 101, which easily causes the tubular body to deform. In order to prevent this from happening and prolonging the service life, a buffer fixing ring is arranged in the tubular body between the orifice of the upper tubular body 11 of the trunk unit 100 and the upper end connecting portion 21 for buffering the gravity of the second trunk unit 102. Slowly, the second trunk unit 102 can be fixed over the first trunk unit 101.

When any two trunk units are connected, the slope of the bevel of the first trunk unit 101 is parallel to the slope of the bevel of the second trunk unit 102, so as to align the positive and negative electrode metal pieces between the two slopes. This requires the second trunk unit 102 to be sleeved into the first trunk unit 101 at a certain angle or rotated to the proper position until it fits. Thus, in some embodiments, a socket mark can be provided at the socket of the first trunk unit 101 and the second trunk unit 102. That is, a socket mark (not shown) is provided on the surfaces of the upper tubular body 11 and the lower tubular body 12 of the trunk unit 100, respectively. Referring to FIG. 2, after the socket mark of the lower tubular body 12 of the second trunk unit 102 is aligned with the socket mark of the upper tubular body 11 of the first trunk unit 101, the second trunk unit 102 is directly sleeved into the first trunk unit 101, then continue to sleeve along the direction of the sleeving until the bevel of the two trunk units is fitted to each other.

Illustratively, a guide block (not shown) is provided on the first trunk unit 101 and a guide groove (not shown) is provided on the second trunk unit 102, or a guide groove (not shown) is provided on the first trunk unit 101, and a guide block (not shown) is provided on the second trunk unit 102, which makes assembly more convenient. In some embodiments, a color block may also be arranged on the first trunk unit 101 and the second trunk unit 102 to refer to the socket mark, and may also be used to identify the location of the connector.

It should be understood that the embodiments of the present invention may also have other application manners, and are not limited to the above application examples. The technical features in the various embodiments and application examples of the present invention can be freely combined without being contradictory.

In the description of the present specification, it is to be understood that the terms “center”, “longitudinal”, “transverse”, “length”, “width”, “thickness”, “upper”, “lower”, “front”, “Rear, Left, Right, Vertical, Horizontal, Top, Bottom, Inner, Out, Clockwise, Counterclockwise, Axial The orientation or positional relationship of the “radial”, “circumferential” and the like is based on the orientation or positional relationship shown in the drawings, and is merely for the convenience of describing the present invention and simplifying the description, and does not indicate or imply the indicated device or The elements must have a particular orientation, are constructed and operated in a particular orientation and are therefore not to be construed as limiting.

Moreover, the terms “first” and “second” are used for descriptive purposes only and are not to be construed as indicating or implying a relative importance or implicitly indicating the number of technical features indicated. Thus, features defining “first” and “second” may comprise one or more of the features either explicitly or implicitly. In the description of the present invention, the meaning of “a plurality” is two or more unless specifically and specifically defined otherwise.

In the present invention, the terms “installation”, “connected”, “connected”, “fixed” and the like shall be understood broadly, and may be either a fixed connection or a detachable connection, unless explicitly stated and defined otherwise, or integrated; can be mechanical connection, electrical connection, or communication; can be directly connected, or indirectly connected through an intermediate medium, can be the internal connection of two components or the interaction of two components. For those skilled in the art, the specific meanings of the above terms in the present invention can be understood on a case-by-case basis.

In the present invention, the first feature “on” or “under” the second feature may comprise direct contact of the first and second features, and may also comprise first and second features, unless otherwise specifically defined and defined. It is not in direct contact but through additional features between them. Moreover, the first feature “above”, “above” and “above” the second feature comprises the first feature directly above and above the second feature, or merely indicating that the first feature level is higher than the second feature. The first feature “below”, “below” and “below” the second feature comprises the first feature directly above and above the second feature, or merely the first feature level being less than the second feature.

The above disclosure provides many different embodiments or examples for implementing different structures of the present invention. In order to simplify the disclosure of the present invention, the components and arrangements of the specific examples are described above. Of course, they are merely examples and are not intended to limit the invention. In addition, the present invention may be repeated with reference to the numerals and/or reference numerals in the various examples, which are for the purpose of simplicity and clarity, and do not indicate the relationship between the various embodiments and/or arrangements discussed.

The above is only the specific embodiment of the present invention, but the scope of the present invention is not limited thereto, and any person skilled in the art can easily think of various changes or within the technical scope of the present disclosure. Instead, these should be covered by the scope of the present invention. Therefore, the scope of the invention should be determined by the scope of the appended claims.

I claim:

1. A Christmas tree comprising a plurality of trunk units that can be connected with each other, and the trunk unit comprising:
a hollow tubular body comprising an upper tubular body and a lower tubular body, wherein the inner diameter of the upper tubular body is slightly larger than the outer diameter of the lower tubular body; and
a power connector comprising an upper end connecting portion arranged in the upper tubular body and a lower end connecting portion arranged at the orifice of the lower tubular body, wherein the upper end connecting portion comprises a first bevel with a positive electrode metal piece and a negative electrode metal piece arranged on the slope of the first bevel, the lower end connecting portion comprises a second bevel with a positive electrode metal piece and a negative electrode metal piece on the slope of the second bevel, and the upper end connecting portion is electrically connected to the lower end connecting portion;
when any two trunk units are connected, the lower tubular body of one of the two trunk units is sleeved into the upper tubular body of the other trunk unit from the orifice of the upper tubular body of the other trunk unit, so that the slope of the second bevel of the lower tubular body of the one of the two trunk units abuts against the slope of the first bevel of the upper tubular body of the other trunk unit, the positive electrode metal piece on the second bevel of the one of the two trunk units abuts against the negative electrode metal piece on the first bevel of the other trunk unit, and the negative electrode metal piece on the second bevel of the one of the two trunk units abuts against the positive electrode metal piece on the first bevel of the other trunk unit.

2. The Christmas tree according to claim 1, wherein the trunk unit further comprises a power interface embedded in a mounting hole arranged on the surface of the tubular body of the trunk unit, and the power interface is electrically connected to the power connector in the tubular body.

3. The Christmas tree according to claim 1, wherein the upper end connecting portion further comprises a first supporting base and a first fixing assembly; the first bevel is on the top of the first supporting base, and the first supporting base is fixed in the upper tubular body by the first fixing assembly, which is configured to support the upper end connecting portion and to make the first bevel towards the orifice of the upper tubular body;
the lower end connecting portion further comprises a second supporting base and a second fixing assembly, the second bevel is on the top of the second supporting table, and the second supporting base is fixed in the lower tubular body by the second fixing assembly, which is configured to support the lower end connecting portion and to make the second bevel towards the orifice of the lower tubular body.

4. The Christmas tree according to claim 3, wherein the fixing assembly comprises a lock snap assembly and/or a threaded assembly.

5. The Christmas tree according to claim 1, wherein a buffer fixing ring is provided in the tubular body between the orifice of the upper tubular body and the upper end connecting portion.

6. The Christmas tree according to claim 1, wherein the surface of the upper tubular body and the lower tubular body of the trunk unit are respectively provided with a socket mark; when any two trunk units are connected, the socket mark of the lower tubular body of one of the two trunk units is aligned with the socket mark of the upper tubular body of the other trunk unit.

7. The Christmas tree according to claim 1, wherein a guide block is arranged on the outer surface of the lower tubular body, and a guide groove is arranged on the inner surface of the upper tubular body; when any two trunk units are connected, the guide block of the lower tubular body of one of the two trunk units slides along the guide groove in the upper tubular body of the other trunk unit, to make the slope of the second bevel of the lower tubular body of the one of the two trunk units abutted against the slope of the first bevel of the upper tubular body of the other trunk unit.

8. The Christmas tree according to claim 6, wherein the socket mark is colored.
